(19) United States
(12) Patent Application Publication
(10) Pub. No.: US 2014/0091078 A1
(43) Pub. Date: Apr. 3, 2014

(54) Receptacle type electric conducting device

(71) Applicant: Chia-Hsiung Wu, Taipei (TW)

(72) Inventor: Chia-Hsiung Wu, Taipei (TW)

(21) Appl. No.: 10/418,269

(22) Filed: Apr. 18, 2003

(51) Int. Cl. A47J 27/62

(52) U.S. Cl. CPC A47J 27/62
USPC 219/518; 219/441

(57) ABSTRACT

A receptacle type electric conducting device wherein many inconveniences and the danger of electric shock can be eliminated by installation of a pressure switch, protected under a narrow slot on the base seat of the electric heater pot. The pressure switch changes the constantly charged condition of pot base seat to one that only allows electric current when the electric heater pot is securely on the base seat, whereby avoiding electric shock from touching a charged empty base seat. The present invention devises the pressure switch under the protection of a narrow slit which only allows the pot base pressure ring to pass through when the electric heater pot is precisely sitting on top. The narrow slot not only safeguards the pressure switch's constantly off condition it also protect the pressure switch from water splashes or insertion of foreign objects.

### BACKGROUND OF THE INVENTION

1) Field of the Invention

The invention relates to an improvement to a receptacle type electric conducting device, specifically the type on the bottom of a conventional electric heater pot that is seated on a base seat with electric power source. The improvement enables the power source on the base seat to be interrupted by a pressure switch when the pot is being lifted and thereby providing precautionary safety measure against accidental electric shocks.

2) Description of the Prior Art

The early method of feeding power to an electric heater pot was to lead the electricity directly to the electric heater on the pot itself through electric wire and a controlling switch or just electric wire with a plug on the receptacle. Recently, provisions were made to have all electric connections lead to a base seat where the pot normally sits on a seat plug. The electric heater on the pot was fed electricity through the pot receptacle such that the electric current is interrupted when the pot is being lifted. It is more convenient and safer to lift up a pot with no wire attached. The base seat is constantly charged with electricity and is devised with a seat plug at the corresponding position relative to the pot receptacle on the pot base. When the pot is being seated back in a downward motion the seat plug on the base seat will conveniently insert into the pot receptacle and restore the electric circuit. However, the seat plug may short circuit and cause electrical shock when comes in contact with finger touch or water drops.

A more recent design aimed to reduce such electric shock hazard by utilizing a conducting ring inserted into a circular receptacle trench while the conducting surfaces are mounted vertically on the ring shape and to along the circular trench wall whereby eliminating the chance for accidental touching. Nevertheless, the circular receptacle ring is still constantly charged with electricity and vulnerable to short circuiting when water drops or foreign object get caught in the trench. Said conducting ring/receptacle trench design is illustrated in FIGS. 1 and 2. FIG. 1 shows that an electric heater pot (1) and pot base (13) are fitted with a pot receptacle (3) while the periphery of pot base (13) has a ring skirt (131), constituting a ring shape base section. A pot handle (11) is fitted with a power switch (12) nearby while a base seat (2) has a base seat plug (4) in corresponding position to the pot receptacle (3) on the bottom of the heater pot (1). The seat plug (4) is directly wired to power source (23) and constantly charged with electricity. The base seat (2) has a positioning ring (21) corresponds to the heater pot (1) ring skirt (131) for circular positioning while a circular groove (22) allows an accurate seat height of heater pot (1) for the adequate insertion/connection depth between the pot receptacle (3) and the seat plug (4) in order to feed electric power into the heater pot (1). Pot receptacle (3) of the heater pot (1) feeds the power supply through the power switch (12) for control then to the internal pot heater (10).

FIG. 1 shows that the seat plug (4) of base seat (2) is protruded upward and FIG. 2 further illustrates the circular vertical conducting plates inside of the seat plug (4) having: central electrode plate (41), peripheral electrode plates (42) and (43) defining a circular groove (40) and a central insertion hole (410) to correspondingly receive the conducting plug (31), conducting rings (32) and (33) of pot receptacle (3) thereby making multiple circuit connections.

Nevertheless the constantly charged electrodes on the seat plug (4) are exposed; the presence of any non-insulating items caught between electrode plates (42), (43) or water drops into the circular groove (40) or the insertion hole (410) are all short circuiting hazards. In order to receive an easy downward motion of the heater pot (1), the seat plug (4) of base seat (2) is to protrude upward and parallel to the counter top whereupon it sits, therefore particularly vulnerable to short circuiting through foreign objects or water drops unless the power source (23) is disconnected. There is a need for safety improvement to devise a precautionary safety measure so that the constantly charged circuitry is to be interrupted once the heater pot (1) is lifted from the base seat (2), eliminating the danger of electric shock.

### SUMMARY OF THE INVENTION

The present invention is thus aimed to provide an improvement of the receptacle type conducting device on the base seat wherein a pressure switch relates to the pressure ring on the pot base so only when the pot is in the sitting position that all conducting terminals are charged with electricity. Once the pot is lifted the pressure switch will also be released to cut off the power supply, avoiding the danger of short circuiting.

### BRIEF DESCRIPTION OF THE DRAWINGS

To enable a further understanding of the said objectives and the technological methods of the invention herein, the brief description of the drawings below is followed by the detailed description of the preferred embodiments:

FIG. 1 is an exploded schematic view showing the pot base, pot receptacle, base seat and seat plug relationship applied on a conventional electrical heater pot.

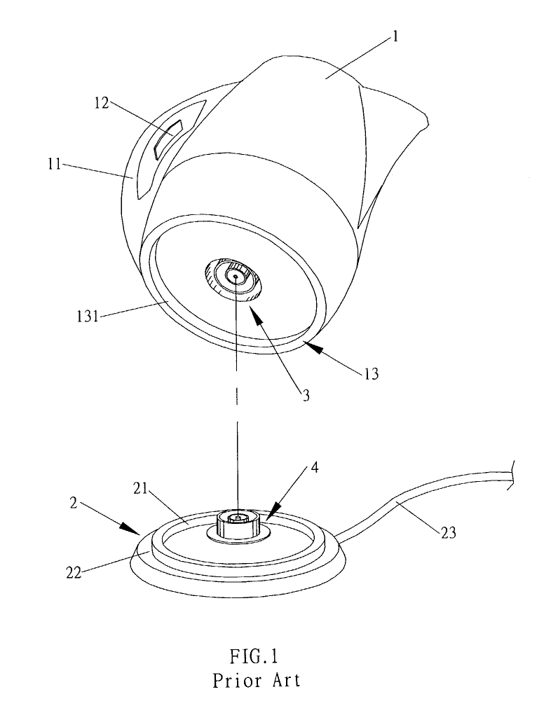

FIG. 2 is a cross-sectional view showing the pot receptacle, seat plug applied on a conventional electrical heater pot.

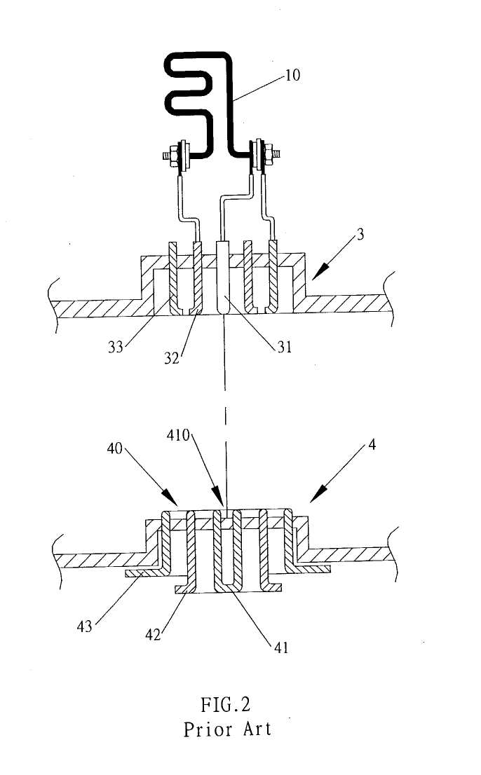

FIG. 3 is a perspective structural view from bottom of the base seat according to the present invention.

FIG. 4 is an exploded and partial cross-sectional view showing the pot base, ring conductor plate, positioning blocks, pressure cylinder, base seat with positioning notch and contact terminals according to the present invention.

### DETAILED DESCRIPTION OF THE PREFERRED EMBODIMENT

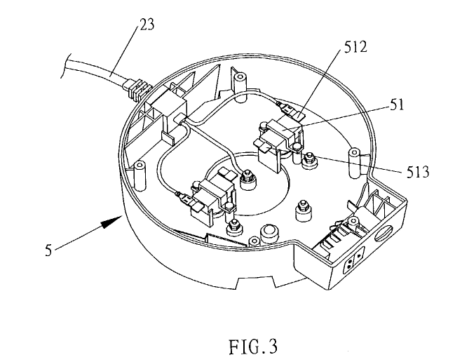

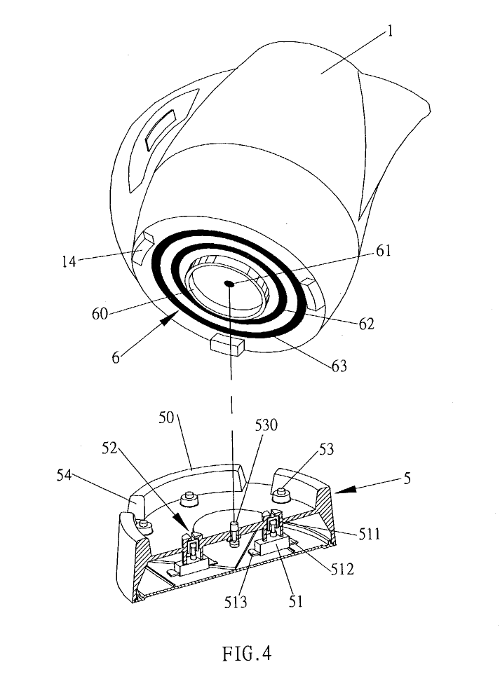

Referring to FIG. 3, a bottom view of a base seat (5) of the present invention where a power source (23) feed electricity first through an incoming conducting terminal (512) then an outgoing terminal (513) of a pressure switch (51), the outgoing electricity feeds into a plurality of up facing conducting terminals (53) while a center terminal (530) serves as a common grounding device (see FIG. 4). The conducting terminals (53) are located according to different radius or different radial orientations so as to correspond to different positioning of ring conductor plates (61) (62) (63) on the bottom of a pot (1) relative to the different circuit loops. By choosing different circuit loops corresponding to different selected conducting terminals will alter the numbers of heater on the circuit therefore controlling the heating power. Said heater comprises of at least two or more of PTC (positive temperature coefficient ceramic resistance) heating units.

The ring conductor plates (61) (62) (63) of electrical heater pot (1) are located on conductor matching disk (6) which fits into the radius of the base plate (5) therein for an accurate fitting and is whereby defined by the peripheral ring blocks (50) from outside for precise positioning. The special precautionary measure devised in the present invention is a pressure switch (51) wherein a sliding block (511) is elastically pushed into an upward position. When a pressure ring (60) of electrical heater pot (1) pushes downward through a narrow slot (52) of the base seat (5) thereby pressing onto the sliding block (511), shifting the pressure switch (51) in position to allow electric current feeding into all the conducting terminals (53). In other words, the conducting terminals (53) can only be electrically charged when the pressure switch is pushed down; once the electric heater pot (1) is lifted, the conducting terminals (53) become disconnected from power source immediately.

The present invention further secures the pot base seat (5) by providing a plurality of positioning notches (54) on the peripheral ring block (50) to receive positioning blocks (14) on the bottom of electrical heater pot (1) into a locking position whereby avoiding any tangential sliding of the ring conducting plates (61) (62) (63), the consequent surface wearing of the conducting plates, possible unsteadiness or jump off of the electric flow.

The pressure switch (51) is pressed down by the sliding block (511) while the sliding block (511) is pushed down by the pressure ring (60) of the electric heater pot (1). The pressure ring (60) of wall thickness of 2˜3 mm or less passes through the narrow slot (52) to press on the pressure switch (51) thereby turning on the electric current. The narrow slot (52) is too thin to allow finger touching and normally the pressure switch (51) can not be manually pressed down unless it is intentionally done with a tool, thus providing the precautionary safety measure.

The pressure ring (60) of electric heater pot (1) is formed into a circular shape in order to provide structural reinforcing of the electric heater pot (1); it also allow a highly flexible matching between the base seat (5) and the pressure ring (60) whereby facilitating the synchronized pressing of the pressure switch (51) to turn on the electric current.

1. A receptacle type electric conducting device having conducting terminals on a base of the electric heater pot in and a pressure switch installed between power source and the conducting terminals whereby to interrupt electric current when the electric heater pot is being lifted from the base seat; the pressure switch is normally protected from on condition to off condition by a narrow slot of the base seat and can only be pressed on by the electric heater pot pressure ring passing through the narrow slot precisely therein.

2. The receptacle type electric conducting device of claim 1, wherein peripheral ring blocks of the base seat is to receive and protect said electric heater pot while positioning notches are formed by the peripheral ring blocks to receive positioning blocks on the base seat for placing the electric heater pot.

3. The receptacle type electric conducting device of claim 1, wherein the pressure ring underneath the electric heater pot is made into a circular shape for more versatile fitting positioning.
